(19) United States
(12) Patent Application Publication
(10) Pub. No.: US 2018/0107262 A1
(43) Pub. Date: Apr. 19, 2018

(54) TEMPORAL THERMAL COUPLING AWARE POWER BUDGETING METHOD

(71) Applicant: AMD Products (China) Co., Ltd., Beijing (CN)

(72) Inventors: Guoqing CHEN, Beijing (CN); Wei HUANG, Beijing (CN)

(21) Appl. No.: 15/573,369

(22) PCT Filed: Oct. 30, 2015
(86) PCT No.: PCT/CN2015/093473

§ 371 Date: Nov. 10, 2017

(30) Foreign Application Priority Data
May 12, 2015 (CN) 201510239507.7

(51) Int. Cl. G06F 1/32

(52) U.S. Cl. CPC G06F 1/3206

(57) ABSTRACT

A power budgeting method comprises predicting a frequency-insensitive phase (S1) and a frequency-sensitive phase (S2) of a program, decreasing the power (P) applied to a processor when the program executed by the processor enters the frequency-insensitive phase and increasing the power applied to the processor when the program executed by the processor enters the frequency-sensitive phase. The method and corresponding system provided by present disclosure can boost the overall performance of executing programs to improve program execution efficiency. In addition, the power budgeting method and system of present disclosure is thermal aware, which can ensure reliability of the processor.

### BACKGROUND OF THE DISCLOSURE

In the computer field, improving the performance of processors is an important aspect. A processor is designed with a range of operating frequencies. The maximum power can be fed to the processor is limited by several factors such as temperature, power supply ability of the power delivery system, and the resistance drop issue of power supply network etc. How to make a processor execute an application or program faster to achieve a better performance within its power limit is a challenging problem.

At present, various ways have been proposed to optimize processor performance within a processor's power limit. For example, one existing method is a cooperative boosting method which is used to do the power management in an accelerated processing unit (APU) system. In this method, the power is allocated between the CPU and GPU to achieve optimal performance by considering the performance coupling and thermal coupling effects.

Another proposed method is a power token balancing method which allocates the power budget in parallel multithreaded workloads to improve performance while maintaining the power in the power budget, i.e. taking power from non-critical threads and applying it to the critical threads. FIG. 1 shows a schematic view of this proposed method, wherein each of cores C1, C2, C3, and C4 are allocated the same amount of power, such as “10” shown in FIG. 1. When the threads in core 2 (C2) and core 3 (C3) reach the barrier and enter the spinning state, they only consume a small amount of power (such as “4” indicated in FIG. 1), then the power token balancing (PTB) units therein can allocate the redundant power budget (i.e. “6” shown in the figure) from core 2/core 3 to core 1 (C1)/core 4 (C4) to speed up the execution of the threads in core 1/core 4, thereby improving the performance of the processor.

### SUMMARY OF EMBODIMENTS OF THE DISCLOSURE

Although the above methods in prior art can improve executing performance, the above existing methods for improving processor performance are based on spatial power allocation and trying to optimize the performance in a given short timing window. These existing methods do not consider the temporal thermal coupling impact on a processor performance and thus there may be a sub-optimal result.

To overcome the shortcomings in existing performance improving methods so as to further optimize the processor performance, the present disclosure provides a temporal thermal coupling aware power budgeting method and system which considers the temporal thermal coupling impact on processor performance.

In a first aspect, a power budgeting method is provided. The method comprises predicting a frequency-insensitive phase and a frequency-sensitive phase of a program; decreasing the power applied to a processor when the program executed by the processor enters the frequency-insensitive phase; and increasing the power applied to the processor when the program executed by the processor enters the frequency-sensitive phase. The frequency-sensitive phase may follow the frequency-insensitive phase, and the power may be applied without exceeding the maximum allowed temperature of the processor.

In a second aspect, a power budgeting method is provided. The method comprises determining a frequency-insensitive thread and a frequency-sensitive thread of multiple programs; assigning the frequency-insensitive thread and the frequency-sensitive thread of the multiple programs to a same core alternatively; decreasing the power applied to the processor when the processor executes the frequency-insensitive thread; and increasing the power applied to the processor when the processor executes the frequency-sensitive thread. The frequency-sensitive thread may follow the frequency-insensitive thread, and the power may be applied without exceeding the maximum allowed temperature of the processor.

In a third aspect, a power budgeting system is provided. The system comprises means for predicting a frequency-insensitive phase and a frequency-sensitive phase of a program; means for decreasing the power applied to a processor when the program executed by the processor enters the frequency-insensitive phase; and means for increasing the power applied to the processor when the program executed by the processor enters the frequency-sensitive phase. The frequency-sensitive phase may be entered following the frequency-insensitive phase, and the power may be applied without exceeding the maximum allowed temperature of the processor.

In a fourth aspect, a power budgeting system is provided. The system comprises means for determining a frequency-insensitive thread and a frequency-sensitive thread of multiple programs; means for assigning the frequency-insensitive thread and the frequency-sensitive thread of the multiple programs to a same core alternatively; means for decreasing the power applied to the processor when the processor executes the frequency-insensitive thread; and means for increasing the power applied to the processor when the processor executes the frequency-sensitive thread. The frequency-sensitive thread may be entered following the frequency-insensitive thread, and the power may be applied without exceeding the maximum allowed temperature of the processor.

By providing the steps in the above mentioned method and above-mentioned system, the present disclosure can overcome the deficiencies in existing power management schemes by optimizing the power applied to the processor temporally and thus can further improve the performance of processors. In addition, the power budgeting method and system of present disclosure is thermal aware, which also can ensure reliability of the processor.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 is a schematic view of a power token balancing method for improving the processor performance in prior art;

FIG. 2 is a schematic diagram which shows (a) the state of power, temperature and maximum allowed temperature in different execution phases of a program according to an existing power management scheme in prior art, compared to (b) the power budgeting method of present disclosure;

FIG. 3 is a flow chart of the temporal thermal coupling aware power budgeting method used during executing a single program; and

FIG. 4 is a flow chart of an exemplary embodiment of the temporal thermal coupling aware power budgeting method used during executing multiple programs.

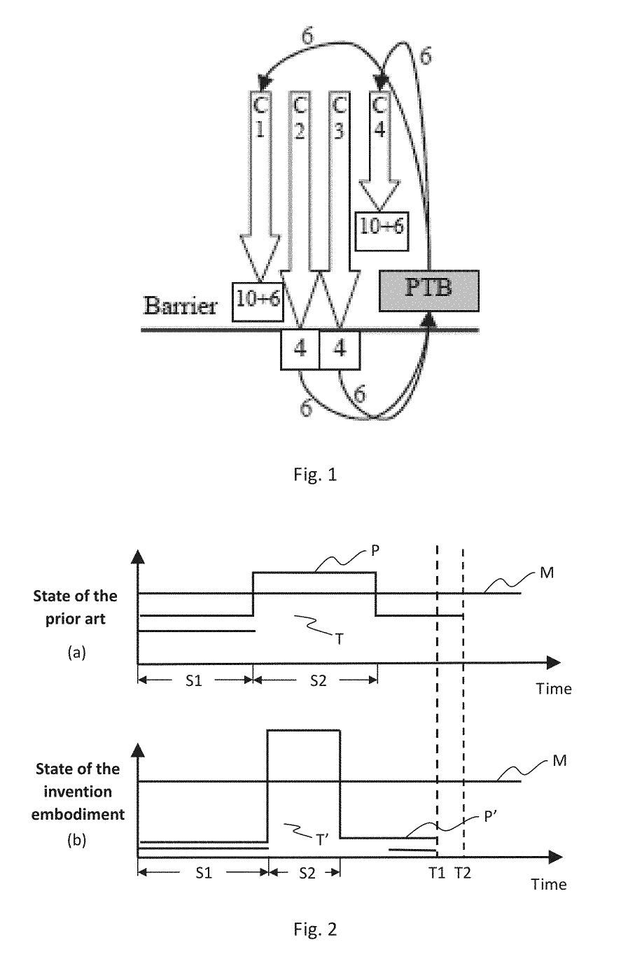

### DETAILED DESCRIPTION OF THE EMBODIMENTS

The present disclosure will now describe in detail with reference to a few aspects thereof as illustrated in the accompanying drawings. In the following description, numerous specific details are set forth in order to provide a thorough understanding of the present disclosure. It will be apparent, however, to one skilled in the art, that the embodiments of the present disclosure may be practiced without some or all of these specific details. In other instances, well known process steps and/or structures have not been described in detail in order to not unnecessarily obscure the present disclosure.

In addition to being influenced by several hardware characteristics such as architecture, size of cache, etc., the performance of a processor is also impacted by the characteristic of the workload or program executed thereon. That is to say, the characteristic of programs or applications also has an influence on the executing performance of a processor. Some applications or programs are frequency-sensitive. When they are executed by a processor, the executing performance of the processor can be boosted significantly with a boost of the operating frequency of the processor. Some applications or programs are frequency-insensitive. When they are executed by a processor, frequency changes have low influence on the executing performance of the processor. Meanwhile, for a single program or application, the frequency sensitivity may also vary in different execution phases. Some execution phases of the program or application may be frequency-insensitive while others may be frequency-sensitive, which also influences the execution performance of a processor.

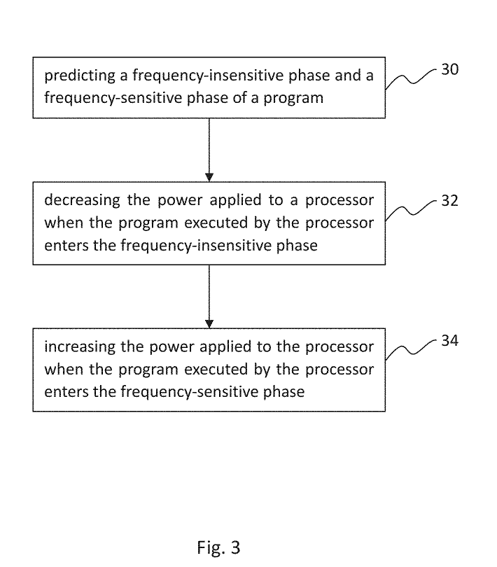

FIG. 2 a schematic diagram which shows the state of power, temperature and maximum allowed temperature in different execution phases of a program or application when the program or application is executed by a processor according to existing power management schemes such as bidirectional application power management (BAPM) in comparison with the temporal thermal coupling aware power budgeting method, respectively. As shown, FIG. 2 includes two diagrams (a) and (b) wherein diagram (a) shows the state of power, temperature and maximum allowed temperature in different execution phases of a program when the program is executed by existing power management scheme such as BAPM, and diagram (b) shows the state of power, temperature and maximum allowed temperature in different execution phases of the program when the program is executed by the temporal thermal coupling aware power budgeting method according to one explanatory embodiment of present disclosure.

In FIG. 2, the two lines M in diagrams (a) and (b) indicate the maximum allowed temperature that the processor can be allowed to reach. The line P indicates the power applied to the processor when it executes a single program according to existing power management scheme, and P′ indicates the power applied to the processor when it executes a single program according to the power budgeting management scheme of the present disclosure. The line T indicates the temperature of the processor when it executes a single program according to existing power management scheme, and T′ indicates the temperature of the processor when it executes a single program according to the power budgeting management scheme of the present disclosure.

As shown in the example shown in FIG. 2, at the beginning, the exemplified program has a frequency-insensitive phase S1, which means the execution performance of the processor is less impacted by the frequency changes. At this phase, as shown in diagram (b), we can make the power P′ applied to the processor lower than the power P (see diagram (a)) according to the prior art, so as to lower the temperature of the processor, which can gain more thermal headroom for this phase, with only slightly degraded performance. For example, we can decrease the operating frequency of the processor to decrease the power of the processor. Then, the program enters a frequency-sensitive phase S2, where the execution performance can be increased significantly with frequency boosting. In this phase, as shown in diagram (b), by using the additional thermal headroom gained during the frequency-insensitive phase S1, we can increase the power P′ applied to the processor in the phase S2 higher than the power P applied to the processor in the same phase shown in diagram (a) without exceeding the maximum allowed temperature M of the processor. Alternatively or in addition, we can increase the power of the processor to a power lower than P′ and run at the power for a longer duration without exceeding the maximum allowed temperature M. In an aspect, we can boost the operating frequency of the processor to increase the power of the processor. In this way, the performance of executing the program can be optimized across a long timing window, thereby achieving a higher performance globally. As shown in FIG. 2, it takes time duration T2 to finish the program using the existing power management scheme such as BAPM. By comparison, with the temporal thermal coupling aware power budgeting method of present disclosure, the program can be finished in a shorter time duration T1.

In an explanatory aspect, FIG. 3 shows a flow chart of the temporal thermal coupling aware power budgeting method used in executing a single program or application. The method comprises the following steps. First, in step 30, predicting a frequency-insensitive phase and a frequency-sensitive phase of a program. Then, in step 32, decreasing the power applied to a processor when the program executed by the processor enters the frequency-insensitive phase. And then, in step 34, the method further comprises increasing the power applied to the processor when the program executed by the processor enters the frequency-sensitive phase. In an embodiment, the frequency-sensitive phase follows the frequency-insensitive phase. In an aspect, the power applied to the processor can be increased or decreased by increasing or decreasing the operating frequency of the processor.

In an aspect, in above step 32, the frequency sensitivity of a current phase and frequency sensitivity of a next phase are used to determine an optimal power budget for the current phase. That is to say, the relative relationship between the sensitivity levels of the current phase and the next phase is used to determine the power decreasing degree in step 32. For example, in an aspect, if the frequency sensitivity level is very low at current phase and very high at next phase, the power for the current phase can be lowered to the minimum level, so that it will not significantly diminish performance of current phase, but can get a highest frequency boost at the next phase. If the frequency sensitivity level for current phase is medium low, and the sensitivity for next phase is medium high, the power for the current phase can be lowered to a relatively low level which is not as aggressive as the first case. In the extreme case, when the frequency sensitivity level for the current and next phases are similar, the power is not lowered.

In an aspect, the frequency-insensitive phase of the program may be, for example, the phase where memory-related operations such as storage operation, access operation etc. are executed. The frequency-sensitive phase of the program may be, for example, the phase where computation-related operations such as arithmetic operations, logical operation etc. are executed.

According to the above method shown in FIG. 3, by decreasing the power applied to the processor when the program enters the frequency-insensitive phase, the processor can operate at a lower temperature, which can provide more temperature headroom (i.e. the difference between the current temperature and the maximum allowed temperature of the processor) which in turn can be used for allowing the processor to operate at a higher power in the frequency-sensitive phase of the program. Through this method, even if the performance in the frequency-insensitive phase may be slightly degraded, the performance in the frequency-sensitive phase will be boosted greatly over the degraded performance in the frequency-insensitive phase. Thus, as a whole, the overall performance of the processor for executing the program is improved.

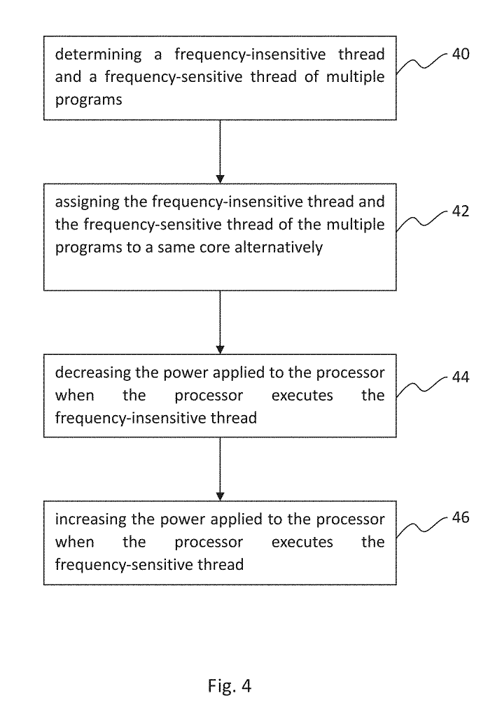

In an aspect, FIG. 4 shows a flow chart of an exemplary embodiment of the temporal thermal coupling aware power budgeting method for executing multiple programs. The method comprises the following steps: First, in step 40, determining a frequency-insensitive thread and a frequency-sensitive thread of multiple programs; then in step 42, assigning the frequency-insensitive thread(s) and the frequency-sensitive thread(s) of the multiple programs to a same core alternatively; then, in step 44, decreasing the power applied to the processor when the processor executes frequency-insensitive thread(s). And in step 46, the method further comprises increasing the power applied to the processor when the processor executes a frequency-sensitive thread. In an aspect, the power may be increased when the processor executes a frequency-sensitive thread following the frequency-insensitive thread without exceeding the maximum allowed temperature of the processor. In an aspect, the power applied to the processor can be increased or decreased by increasing or decreasing the operating frequency of the processor. In an aspect, the frequency-insensitive thread of the programs may be, for example, the thread comprising memory-related operations such as storage operation, access operation etc. The frequency-sensitive thread of the programs may be, for example, the thread comprising computation-related operations such as arithmetic operations, logical operation etc.

In an aspect, in above step 44, the frequency sensitivity of a current thread and frequency sensitivity of a next thread are used to determine an optimal power budget for the current thread. That is to say, the relative relationship between the sensitivity levels of the current thread and the next thread is used to determine the power decreasing degree in step 44. For example, in an aspect, if the frequency sensitivity level is very low at current thread and very high at next thread, the power for the current thread can be lowered to the minimum level, so that it will not significantly diminish performance of current thread, but can get a highest frequency boost at the next thread. If the frequency sensitivity level for current thread is medium low, and the sensitivity for next thread is medium high, the power for the current thread can be lowered to a relatively low level which is not as aggressive as the first case. In the extreme case, when the frequency sensitivity level for the current and next threads are similar, the power is not lowered.

According to above method shown in FIG. 4, by decreasing the power applied to the processor when the processor executes the frequency-insensitive thread(s), the processor can operate at a lower temperature, which can provide more temperature headroom which in turn can be used for allowing the processor to operate at a higher power in executing frequency-sensitive thread(s) of the programs. Through this method, even if the performance in executing the frequency-insensitive thread may be slightly degraded, the performance in executing the frequency-sensitive thread will be boosted greatly over the degraded performance. Thus, as a whole, the overall performance of the processor for executing the multiple programs is improved.

In addition to improving the overall performance for executing programs, the described power budgeting methods of embodiments of the present disclosure also can produce other benefits. For example, the power budgeting method of the present disclosure is thermal aware, which can ensure reliability of the processor. And, the power budgeting methods of present disclosure is a power budgeting method based on temporal power allocation, which can also be combined with other spatial power budgeting methods to achieve a comprehensive spatial and temporal optimization of performance of processors.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable media include, but are not limited to: magnetic media such as hard disks, floppy disks, and magnetic tape; optical media such as CD-ROMs and holographic devices; magneto-optical media such floptical disks; and hardware devices that are specially configured to store and execute program code, such as application-specific integrated circuits (ASICs), programmable logic devices and ROM and RAM devices.

It will be apparent to those skilled in the art that various modifications and variations can be made to the embodiments described herein without departing from the spirit and scope of the claimed subject matter. Thus, it is intended that the specification covers modifications and variations of the various embodiments described herein, provided such modification and variations come within the scope of the appended claims and their equivalents.

What is claimed is:

1. A power budgeting method, comprising:
predicting a frequency-insensitive phase and a frequency-sensitive phase of a program;
decreasing the power applied to a processor when the program executed by the processor enters the frequency-insensitive phase; and
increasing the power applied to the processor when the program executed by the processor enters the frequency-sensitive phase.

2. The method of claim 1, wherein the frequency-sensitive phase follows the frequency-insensitive phase.

3. The method of claim 2, wherein the power applied to the processor is decreased based on the relative relationship between frequency sensitivity levels of a current phase and the next phase.

4. The method of claim 1, wherein the decreasing the power applied to the processor comprises decreasing an operating frequency of the processor, and the increasing the power applied to the processor comprises increasing the operating frequency of the processor.

5. The method of claim 1, wherein the frequency-insensitive phase is a phase in which memory-related operations are executed, and the frequency-sensitive phase is a phase in which computation-related operations are executed.

6. A power budgeting method, comprising:
determining a frequency-insensitive thread and a frequency-sensitive thread of multiple programs;
assigning the frequency-insensitive thread and the frequency-sensitive thread of the multiple programs to a same core of a processor alternatively;
decreasing a power applied to the processor when the processor executes the frequency-insensitive thread; and
increasing the power applied to the processor when the processor executes the frequency-sensitive thread.

7. The method of claim 6, wherein the frequency-sensitive thread follows the frequency-insensitive thread.

8. The method of claim 7, wherein the power applied to the processor is decreased based on the relative relationship between frequency sensitivity levels of a current thread and the next thread.

9. The method of claim 6, wherein the decreasing the power applied to the processor comprises decreasing an operating frequency of the processor, and the increasing the power applied to the processor comprises increasing the operating frequency of the processor.

10. The method of claim 6, wherein the frequency-insensitive thread is a thread comprising memory-related operations, and the frequency-sensitive thread is a thread comprising computation-related operations.

11. A power budgeting system, comprising:
means for predicting a frequency-insensitive phase and a frequency-sensitive phase of a program;
means for decreasing the power applied to a processor when the program executed by the processor enters the frequency-insensitive phase; and
means for increasing the power applied to the processor when the program executed by the processor enters the frequency-sensitive phase.

12. The system of claim 11, wherein the frequency-sensitive phase follows the frequency-insensitive phase.

13. The system of claim 12, wherein the power applied to the processor is decreased based on the relative relationship between frequency sensitivity levels of a current phase and the next phase.

14. The system of claim 11, wherein the means for decreasing the power applied to the processor comprising means for decreasing an operating frequency of the processor, and the means for increasing the power applied to the processor comprising means for increasing the operating frequency of the processor.

15. The system of claim 11, wherein the frequency-insensitive phase is a phase in which memory-related operations are executed, and the frequency-sensitive phase is a phase in which computation-related operations are executed.

16. A power budgeting system, comprising:
means for determining a frequency-insensitive thread and a frequency-sensitive thread of multiple programs;
means for assigning the frequency-insensitive thread and the frequency-sensitive thread of the multiple programs to a same core of a processor alternatively;
means for decreasing power applied to the processor when the processor executes the frequency-insensitive thread; and
means for increasing the power applied to the processor when the processor executes the frequency-sensitive thread.

17. The system of claim 16, wherein the frequency-sensitive thread follows the frequency-insensitive thread.

18. The system of claim 17, wherein the power applied to the processor is decreased based on the relative relationship between frequency sensitivity levels of a current thread and the next thread.

19. The system of claim 16, wherein the means for decreasing the power applied to the processor comprises means for decreasing an operating frequency of the processor, and the means for increasing the power applied to the processor comprises means for increasing the operating frequency of the processor.

20. The system of claim 16, wherein the frequency-insensitive thread is a thread comprising memory-related operations, and the frequency-sensitive phase is a thread comprising computation-related operations.
